(19) United States
(12) Patent Application Publication
(10) Pub. No.: US 2013/0304485 A1
(43) Pub. Date: Nov. 14, 2013

(54) Method of referring patients to healthcare providers

(71) Applicants: Mujtaba Ali Khan, The Woodlands, TX (US); Ali Akbar Bhuriwala, Montgomery, TX (US)

(72) Inventors: Mujtaba Ali Khan, The Woodlands, TX (US); Ali Akbar Bhuriwala, Montgomery, TX (US)

(21) Appl. No.: 13/506,712

(22) Filed: May 11, 2012

(51) Int. Cl. G06Q 50/22

(52) U.S. Cl. 705/2

(57) ABSTRACT

A method of referring patients to healthcare providers may drastically reduce the inefficiencies of current referral systems and may enable healthcare providers to focus more time, energy, and financial resources on patient care. In one embodiment, an ill patient may be referred to a hospital using a direct admit system for hospitals (“DASH”) that streamlines the hospital admission process for ill patients being assessed by clinicians in outpatient or inpatient medical facilities. In another embodiment, a direct online contact system for healthcare providers (“DOC-Connect”) may streamline communication between clinicians and various healthcare facilities and services. DOC-Connect may provide a method for ensuring efficient and appropriate transmittal and scheduling of referrals and services requiring further care by directly connecting a clinician or other healthcare provider acting as a healthcare referral initiator with another healthcare provider acting as a healthcare referral recipient using a central management system.

### CROSS-REFERENCE TO RELATED APPLICATION

This application claims priority to U.S. Provisional Patent Application No. 61/482,594, filed May 4, 2011.

### BACKGROUND

1. Field of the Invention

The present disclosure relates to a method of referring patients to healthcare providers.

2. Description of the Related Art

The healthcare industry has faced numerous challenges in recent years, including a sicker population, overburdened healthcare providers, and skyrocketing costs. Poor communication between stakeholders—patients, providers, and institutions—is often the root cause of inadequate medical treatment, unnecessary error, excess cost, and even death.

The hospital admission process used in most hospitals is currently plagued by delays that may cause the loss of critical time that could otherwise be spent treating an ill patient. These delays include filling out lengthy forms which often duplicate information that the ill patient has already provided to the referring outpatient or inpatient medical facility. In addition, the current hospital admission process also often results in redundant testing that wastes resources and may in many cases cause harm to or delay the recovery of the patient. U.S. Patent Appl. Publ. No. 2002/0013714 to Dubler et al. discloses a method of exchanging information between doctors and hospitals that can reduce some of these delays.

Similarly, the process for referring patients to healthcare specialists and providers such as pharmacies, medical testing facilities, medical supply facilities, and other providers of healthcare services is currently iterative. The referring healthcare provider must consider possible options iteratively until a possible viable option is identified. However, the referring healthcare provider will still not know if a better alternative exists, such as a specialist with an earlier available appointment or more experience treating a particular condition.

The present disclosure describes a method of referring patients to healthcare providers that may drastically reduce the inefficiencies of current referral systems and may enable healthcare providers to focus more time, energy, and financial resources on patient care.

### SUMMARY

A method of referring patients to healthcare providers is disclosed herein. The method may drastically reduce the inefficiencies of current referral systems and may enable healthcare providers to focus more time, energy, and financial resources on patient care. In one embodiment, an ill patient may be referred to a hospital using a direct admit system for hospitals (“DASH”) that streamlines the hospital admission process for ill patients being assessed by clinicians in outpatient or inpatient medical facilities. DASH provides a systematic process for admitting an ill patient and employs one or more methods of communication between an outpatient or inpatient medical facility and/or clinician assessing said ill patient and a hospital or regional transfer center that will admit said patient. DASH allows prompt admission of an ill patient directly into a hospital and assists the ill patient in avoiding costly and time consuming emergency room visits. In another embodiment, a direct online contact system for healthcare providers (“DOC-Connect”) may streamline communication between clinicians and various healthcare facilities and services. DOC-Connect may provide a method for ensuring efficient and appropriate transmittal and scheduling of referrals and services requiring further care by directly connecting a clinician or other healthcare provider acting as a healthcare referral initiator with another healthcare provider acting as a healthcare referral recipient using a central management system.

### BRIEF DESCRIPTION OF THE DRAWINGS

FIG. 1 shows the process flow for patient admission via a DASH-enabled hospital or regional transfer center.

FIG. 2 shows the process for patient care using DASH.

FIG. 3 shows the process for patient care using DASH.

### DETAILED DESCRIPTION OF THE PREFERRED EMBODIMENTS

The present disclosure describes a method of referring patients to healthcare providers. The method may drastically reduce the inefficiencies of current referral systems and may enable healthcare providers to focus more time, energy, and financial resources on patient care.

As used herein, a healthcare provider may be any provider of healthcare services, such as a hospital, a physician or other clinician, an inpatient or outpatient medical facility, a pharmacy, a medical testing facility such as an imaging facility or laboratory, a medical supply facility, an extended care facility such as a long term acute care facility or nursing home, or any other provider of healthcare services.

As used herein, a computer may refer to a desktop, laptop, or other computer, a tablet, a cellular telephone or other mobile device, or any other device comprising a computer processor.

### Direct Admit System for Hospitals

In one embodiment, a direct admit system for hospitals (“DASH”) streamlines the hospital admission process for an ill patient being assessed by a clinician in an outpatient or inpatient medical facility. DASH provides a systematic process for admitting an ill patient and may employ one or more methods of communication between an outpatient or inpatient medical facility and/or clinician assessing said ill patient and a hospital or regional transfer center that will admit said patient. DASH may allow prompt admission of an ill patient directly into a hospital and may assist the ill patient in avoiding costly and time consuming emergency room visits.

In one embodiment, a patient visits an outpatient or inpatient medical facility to obtain medical care. The outpatient medical facility may be a primary care clinic, a specialist clinic, an urgent care center, a free standing emergency room, or another facility providing outpatient medical care. The inpatient medical facility may be a facility that cannot provide the level of care that the patient requires. When a clinician at the outpatient or inpatient medical facility determines that the patient is sufficiently ill to require hospital admission or transfer to another hospital, the clinician may use a direct admit application (“DAA”) on a desktop, laptop, or other computer or on a cellular telephone or other mobile device, or a direct admit button (“DAB”) that is connected to a desktop, laptop, or other computer to initiate the process of hospital admission. The DAB may be connected to the desktop, laptop, or other computer via a universal serial bus (USB) cable.

In one embodiment, the DAB comprises a device that can be depressed to trigger a desired response. The desired response may be to load a website for a desired hospitalist group. The website may comprise information specifically tailored for the clinician accessing the website via the DAB.

In one embodiment, after initiating the hospital admission process using the DAA or the DAB, the clinician or another user may answer questions regarding the patient, the patient's condition, and the presumed diagnosis using a direct admit form (“DAF”). The DAF may comprise a web-enabled form that may be submitted electronically to a hospital or regional transfer center. In one embodiment, the DAF is linked to a web portal at a DASH-enabled hospital or regional transfer center. Information specific to the outpatient or inpatient medical facility may be pre-populated on the DAF, thereby allowing the clinician or other user to enter only information that is specific to the ill patient. The DAF may comprise inquiries regarding patient demographics, the suspected diagnosis, and/or preliminary orders desired by the referring clinician. The DAF may also allow the clinician or other user to upload the patient's medical records. After the clinician or other user submits the completed DAF, messages may be transmitted electronically to the DASH-enabled hospital or regional transfer center.

Regional transfer centers are generally operated by a hospital system that manages or owns multiple hospitals and regulates patient admissions to its hospitals from other medical facilities.

The web portal will comply with all HIPAA requirements and policy guidelines. In addition, the web portal will be secure, which may entail use of a username and encrypted password and/or capture of the IP address accessing the website to ensure that only active personnel at an affiliated outpatient or inpatient medical facility and active hospital personnel may access patient information. The security may further be enhanced through linkage to a database comprising information on affiliated outpatient or inpatient medical facilities, hospitals, medical staff, and hospitalists and also comprising patient medical records.

In one embodiment, a hospitalist on-call (“HOC”) and a hospital bed coordinator (“HBC”) at a DASH-enabled hospital receive the DAF via short message service (SMS) text message and/or electronic mail. In another embodiment, a DASH-enabled regional transfer center receives the DAF. The DAF is then forwarded to an HOC and an HBC at the hospital that can provide the appropriate level of care that is closest to the patient or another hospital that is close to the patient.

In one embodiment, upon receiving the DAF the HBC determines hospital bed availability. If a hospital bed is available, the HBC may initiate the admission process by sending a message via a web portal at a DASH-enabled hospital to the referring clinician and/or outpatient or inpatient medical facility, the HOC, the patient, and/or the assigned nurse or charge nurse. The message to the referring clinician and/or outpatient or inpatient medical facility may preferably comprise a bed confirmation notice and detailed instructions regarding the admission process. The message to the HOC may preferably comprise a bed confirmation notice and the identity of the assigned nurse. The message to the patient may preferably comprise a bed confirmation notice, the identity of the assigned HOC, nurse, hospital floor, and room number, a map and directions to the hospital, and detailed instructions regarding the admission process. The message to the assigned nurse or charge nurse may preferably comprise a bed confirmation notice and a copy of the submitted DAF.

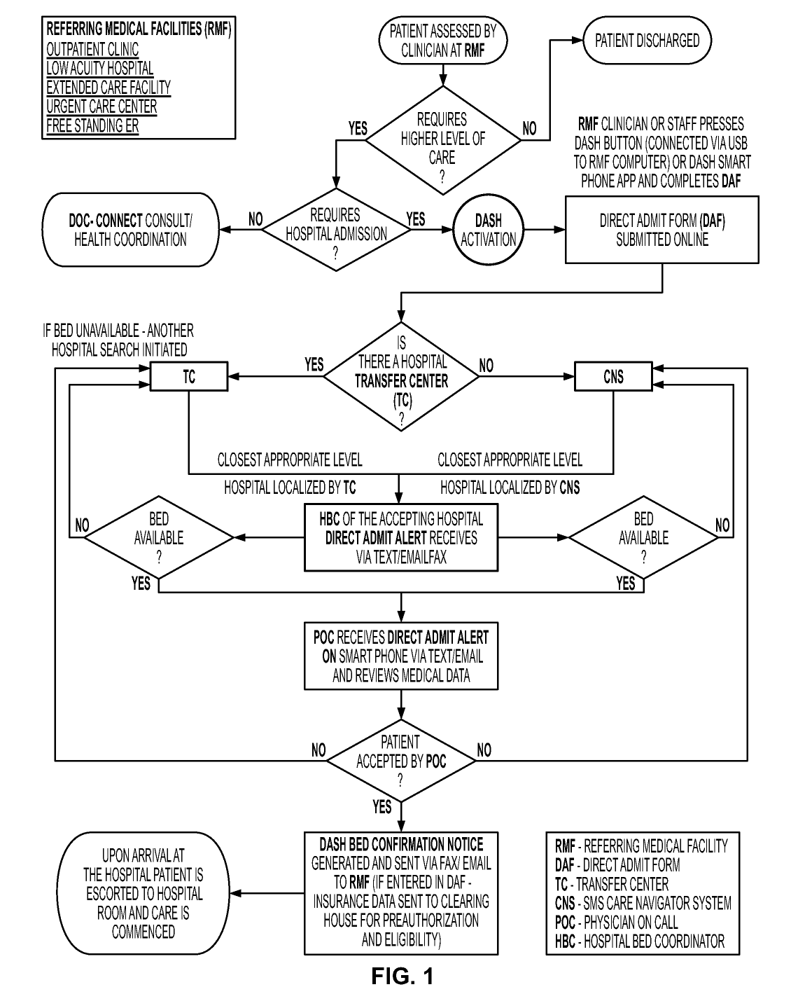

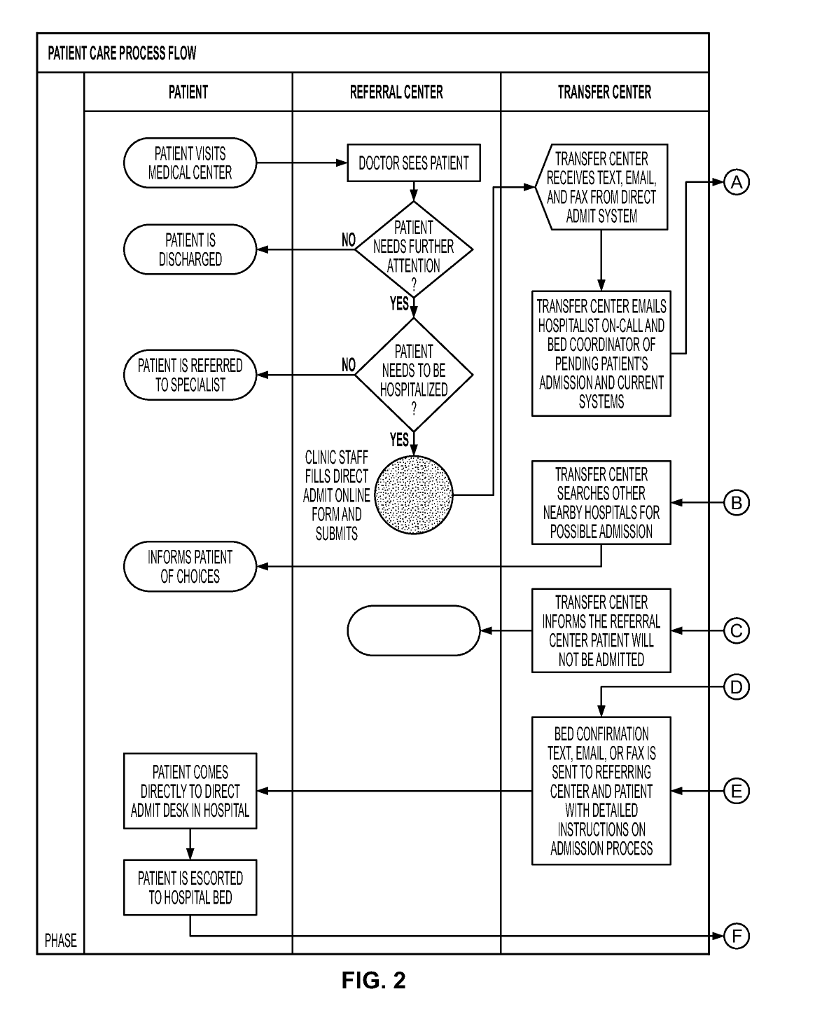

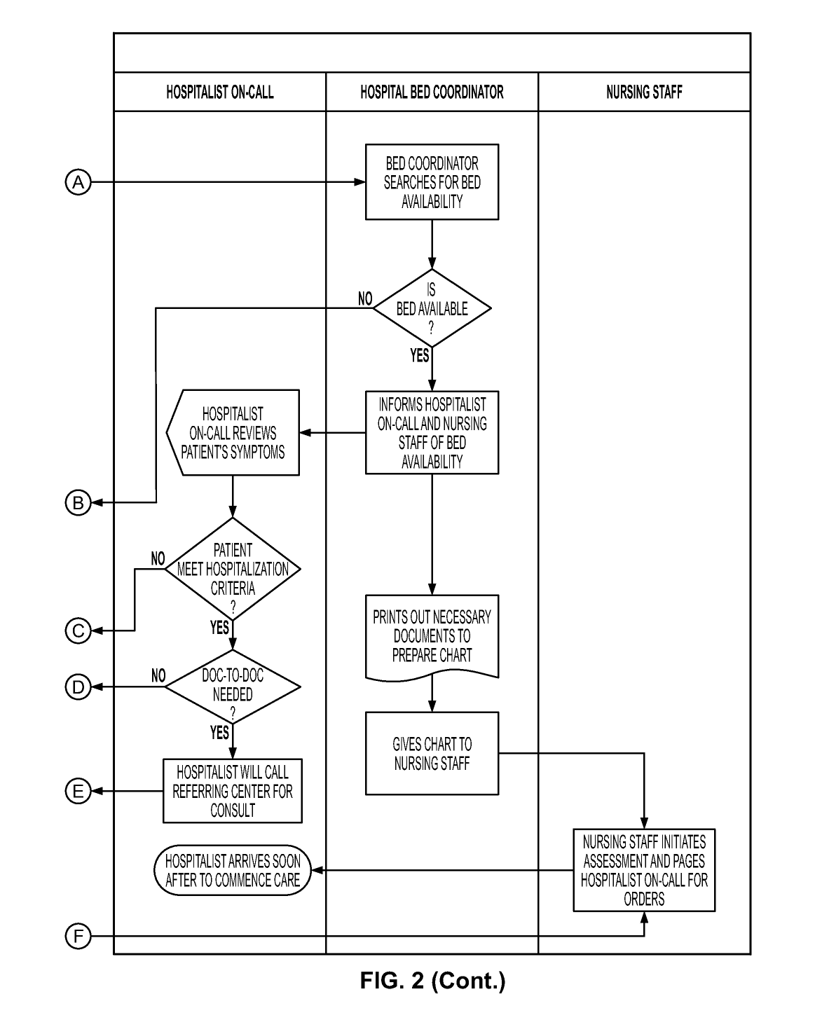

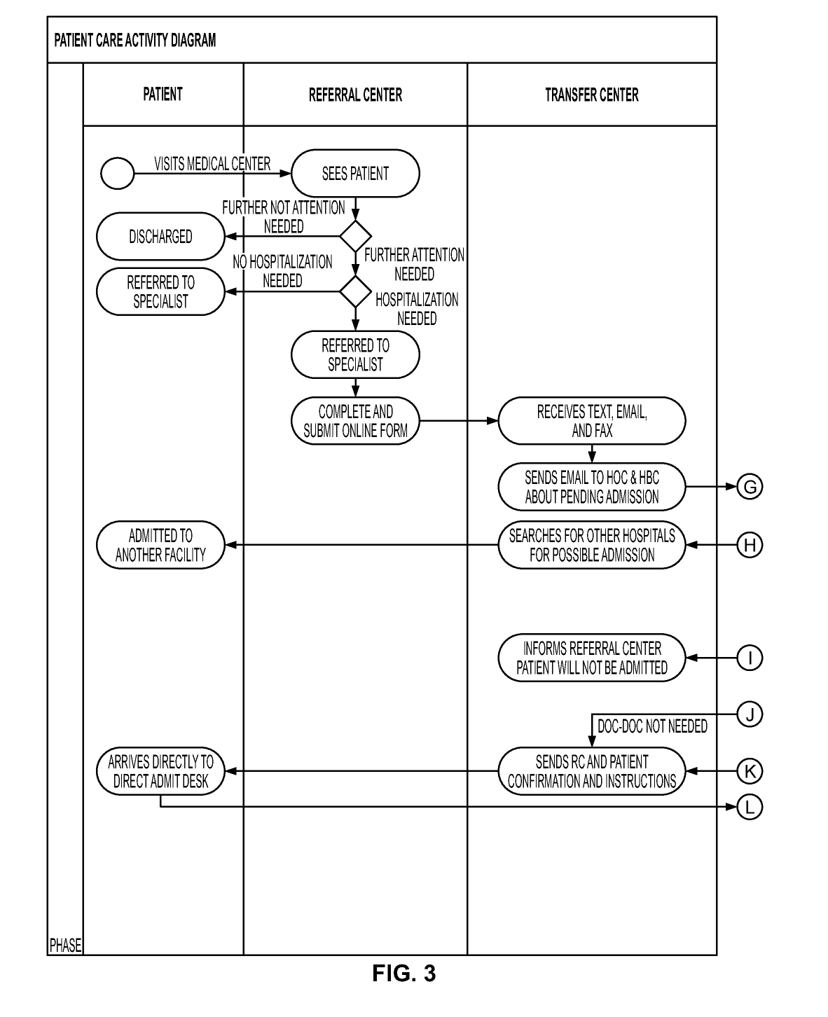

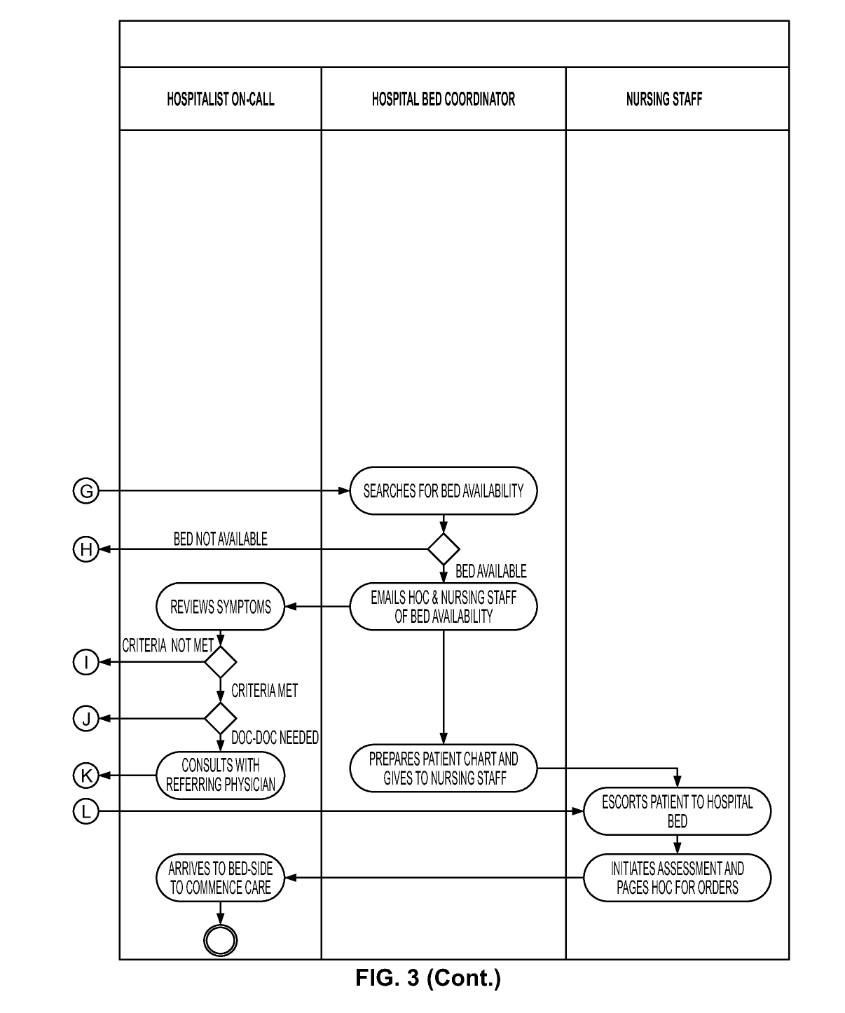

Alternatively, the HBC may initiate the admission process by sending a notice that no bed is available to a DASH-enabled regional transfer facility via a web portal. The DASH-enabled regional transfer facility may then redirect the patient to another DASH-enabled hospital which can accommodate the patient. FIG. 1 shows the process flow for patient admission via a DASH-enabled hospital or regional transfer center. FIGS. 2 and 3 illustrate the process of patient care using DASH.

In one embodiment, during the patient's hospital stay the HOC and/or another hospitalist will administer care as needed. The hospital staff will monitor the patient's status as needed. If there is a change in the patient's condition, the hospital staff may contact the HOC and/or another hospitalist using a page button provided to the charge nurse. The page button will connect the charge nurse to the web portal and the nurse may enter a brief description of the changes into a patient care form found in the patient's record. After the nurse completes and submits the patient care form, a message will be sent to the HOC and/or another hospitalist via SMS text message and/or electronic mail. The HOC and/or another hospitalist will then care for the patient. This cycle may repeat as necessary to maintain the patient's recovery and progress.

In one embodiment, the page button comprises a device that may be depressed to trigger a desired response. The page button may be linked to a computer via a USB cable. The desired response may be to load a website. The website may comprise information specifically tailored for the charge nurse accessing the website via the page button. The specifically tailored information may comprise a drop-down list of patients the charge nurse is overseeing at the time. When the HOC and/or another hospitalist determines that the patient has stabilized, the HOC and/or another hospitalist and the hospital staff may discharge the patient. In one embodiment, after discharging the patient, the hospitalist may make the patient's medical records available to the referring outpatient or inpatient medical facility and referring clinician through the DASH-enabled hospital's web portal. All patient information that is shared will be in accordance with HIPAA requirements.

### Direct Online Contact for Healthcare Providers (“DOC-Connect”)

In one embodiment, a direct online contact system for healthcare providers (“DOC-Connect”) may streamline communication between clinicians and various healthcare facilities and services. DOC-Connect may provide a method for ensuring efficient and appropriate transmittal and scheduling of referrals and services requiring further care by directly connecting a clinician or other healthcare provider acting as a healthcare referral initiator with another healthcare provider acting as a healthcare referral recipient using a central management system.

In one embodiment, the central management system is accessible via a web portal. Accessing the web portal may open an information intake form (“IIF”). Information specific to the referral initiator may be pre-populated on the IIF, thereby allowing the referral initiator to enter only information that is specific to the ill patient. The IIF may comprise inquiries regarding referral orders desired by the referral initiator. The IIF may also allow the referral initiator to upload the patient's medical records. After the referral initiator submits the completed IIF, messages are submitted electronically to the referral recipient.

The web portal will comply with all HIPAA requirements and policy guidelines. In addition, the web portal will be secure, which may entail use of a username and encrypted password and/or capture of the IP address accessing the website to ensure that only active personnel authorized by an affiliated referral initiator may access patient information. The security may further be enhanced through linkage to a database comprising information on affiliated referral initiators and also comprising patient medical records. In one embodiment, a referral recipient receives the IIF via SMS text message and/or electronic mail.

DOC-Connect may provide the referral initiator with a number of possible referral recipients, allowing the referral initiator to identify the most appropriate referral recipient based on whatever parameters the referral initiator deems most important, such as the potential referral recipient's location, availability, and/or level of specialization or expertise in a given area, and/or any other relevant parameter.

In one embodiment, a clinician may use DOC-Connect to schedule a consult with a medical consultant. In another embodiment, a physician may use DOC-Connect to refer a patient to a specialist physician. In another embodiment, a clinician, nurse, or other caregiver may use DOC-Connect to alert a physician of a noteworthy medical situation or condition. In another embodiment, a clinician or hospital case manager may use DOC-Connect to coordinate a patient discharge with a primary, specialty, and/or rehab physician, a long term acute care facility or nursing home, and/or a pharmacy. In another embodiment, a clinician or hospital case manager may use DOC-Connect to facilitate health services provided by a hospital, laboratory, imaging facility, or ancillary service provider.

In one embodiment, a nurse may use DOC-Connect to alert a physician directly via SMS text message, electronic mail, or DOC-Connect application regarding abnormal laboratory results, a change in patient clinical status, or other pertinent information without having to communicate via an answering service. The physician can acknowledge receipt of the communication via SMS text message, electronic mail, or DOC-Connect application, call the nurse, or present in person depending on the level of urgency the nurse expressed in the alert. This may save critical time that would otherwise be wasted in waiting for a returned call, and may reduce the inefficiencies of using an answering service.

In one embodiment, the method of referral using DOC-Connect may comprise the following steps: (1) a healthcare provider assesses a patient and determines that further specialty service is required; (2) the healthcare provider or another referral initiator activates DOC-Connect using a cellular telephone or other mobile device, a desktop, laptop, or other computer, a DOC-Connect button (“DCB”), or another device; (3) the referral initiator completes and submits a HIPAA-compliant IIF which may comprise an option to upload the patient's medical records; 4) the closest appropriate referral recipient or a range of possible referral recipients is automatically identified; 5) a mutually acceptable appointment or service time is scheduled; and 6) confirmation of the referral or appointment is sent via SMS text message, electronic mail, facsimile, or a DOC-Connect application to the referral initiator, referral recipient, patient, and/or any other relevant parties.

The DOC-Connect button (“DCB”) may be connected to a desktop, laptop, or other computer. In one embodiment, the DCB is connected to the desktop, laptop, or other computer via a USB cable. In one embodiment, the DCB comprises a device that can be depressed to trigger a desired response. The desired response may be to load a website specific to the referral initiator. The website may comprise information specifically tailored for the referral initiator accessing the website via the DCB.

In one embodiment, prior to the patient's appointment or service, eligibility, and prior-authorization services may be performed.

### Implementation

The disclosed method may be implemented via a software application, which may be executed in a computer system or mobile device in a conventional manner. Using well-known techniques, the application software may be stored in a data storage medium on an application server and may subsequently be loaded into and executed within the computer system or mobile device.

In one embodiment, upon initiation, DASH software may operate in the manner described below:

1. a DASH initiator invokes a DAA webpage using a web browser from a desktop, laptop, or other computer, a cellular telephone or other mobile device, or using a DAB;

2. the DAA loads the page with a DAF to collect patient medical information, referring physician information, and any other pertinent medical information regarding the patient;

3. the DASH initiator or another individual enters pertinent data into the DAF and then submits the DAF;

4. upon submission, the data in the DAF is transmitted to a DAA server;

5. the data from the DAF is stored in a database and is retained, ensuring HIPAA-compliance and providing access to the information at a later time as needed;

6. the DAA server sends a confirmation notice to the DASH initiator, preferably by electronic mail or SMS text message, informing the DASH initiator of the submission;

7. an HOC and an HBC at a possible referral recipient facility are informed of the referral request, preferably using electronic mail notification and Health Level Seven (HL7) inter-operability standards;

8. the notices transmitted to the HOC and HBC may provide the HOC and HBC respectively with an option to confirm acceptance of the referred patient, and if the HOC and HBC both confirm acceptance of the patient, the DAA server may send a confirmation notice to the DASH initiator via facsimile, SMS text message, and/or electronic mail, based on the DASH initiator's pre-defined preferences;

9. the DAA server may also send a confirmation notice to the patient, if the relevant corresponding information—electronic mail address, cellular telephone number, or facsimile number—was also entered at the time of submission of the DAF;

10. if for any reason the HOC declines the request, the DAA server sends an alert to the HBC and provides an option to re-route the request to another HOC;

11. if for any reason the HBC declines the request, the DAA server sends an alert to the transfer desk and the transfer desk may then route that request to a different hospital, HBC, and HOC, and steps 7 through 9 will repeat.

In another embodiment, upon initiation, DOC-Connect software may operate in the manner described below:

1. a DOC-Connect referral initiator invokes a DOC-Connect webpage using a web browser from a desktop, laptop, or other computer, a cellular telephone or other mobile device, or using a DCB;

2. the DOC-Connect software loads the page with an IIF to collect patient medical information, referral initiator information, and any other pertinent medical information regarding the patient;

3. the referral initiator or another individual enters pertinent data into the IIF and then submits the IIF;

4. upon submission, the data in the IIF is transmitted to a DOC-Connect server;

5. the data from the IIF is stored in a database and is retained, ensuring HIPAA-compliance and providing access to the information at a later time as needed;

6. the DOC-Connect server sends a confirmation notice to the referral initiator, preferably by electronic mail or SMS text message, informing the referral initiator of the submission;

7. a potential referral recipient is informed of the referral request, preferably using electronic mail notification and Health Level Seven (HL7) inter-operability standards;

8. the notices transmitted to the potential referral recipient may provide the potential referral recipient with an option to confirm acceptance of the referred patient, and if the potential referral recipient confirms acceptance of the patient, the DOC-Connect server may send a confirmation notice to the referral initiator via facsimile, SMS text message, and/or electronic mail, based on the referral initiator's pre-defined preferences;

9. the DOC-Connect server may also send a confirmation notice to the patient, if the relevant corresponding information—electronic mail address, cellular telephone number, or facsimile number—was also entered at the time of submission of the IIF;

10. if for any reason the potential referral recipient declines the request, the DOC-Connect server sends an alert to the referral initiator and provides an option to re-route the request to another potential referral recipient and steps 7 through 9 will repeat.

The examples above are intended to be illustrative and not to limit or otherwise restrict the invention. All references cited herein are expressly incorporated by reference.

What is claimed is:

1. A computer-implemented method of referring a patient to a healthcare provider comprising:
providing a local computer accessible to a referral initiator, said local computer comprising a computer processor, computer readable storage media coupled to the processor, a network interface coupled to the processor, and software stored in the computer readable storage media and executable by the processor;
providing one or more local computers accessible to one or more referral recipients, wherein each local computer comprises a computer processor, computer readable storage media coupled to the processor, a network interface coupled to the processor, and software stored in the computer readable storage media and executable by the processor;
providing a server comprising a computer processor, computer readable storage media coupled to the processor, a network interface coupled to the processor, and software stored in the computer readable storage media and executable by the processor; and
carrying out the following steps:
a. creating a referral request using the software stored in the computer readable storage media of the local computer accessible to the referral initiator;
b. inputting data regarding said referral request into a form generated by the software stored in the computer readable storage media of the local computer accessible to the referral initiator, wherein the data is stored on the computer readable storage media on the local computer accessible to the referral initiator;
c. transmitting said data from the computer readable storage media on the local computer accessible to the referral initiator to the computer readable storage media on the server via a network;
d. transmitting a confirmation notice of successful transmission of the referral request to the server via the network to a device designated by the referral initiator;
e. transmitting a referral request notice to a local computer accessible to a referral recipient;
f. creating a referral response using the software stored in the computer readable storage media of the local computer accessible to the referral recipient, wherein said referral response is acceptance or rejection of the referral request;
g. transmitting the referral response to the server via the network;
h. transmitting a confirmation notice identifying the referral response to one or more devices designated by the referral initiator via the network;
i. repeating steps (e) through (h) if the referral response is rejection;
j. transmitting a confirmation notice identifying the referral response to one or more devices designated by the referral initiator and to one or more devices designated by the referral recipient if the referral response is acceptance; and
k. initiating a patient referral to the referral recipient if the referral response is acceptance.

2. The method of claim 1 wherein the referral initiator is an inpatient or outpatient medical facility.

3. The method of claim 2 wherein the referral initiator is an inpatient medical facility.

4. The method of claim 2 wherein the referral initiator is an outpatient medical facility.

5. The method of claim 1 wherein the referral recipient is a hospital or regional transfer center.

6. The method of claim 1 wherein the referral initiator is a clinician.

7. The method of claim 6 wherein the clinician is a physician.

8. The method of claim 5 wherein the referral initiator is a clinician.

9. The method of claim 8 wherein the clinician is a physician.

10. The method of claim 1 wherein the referral recipient is a specialist physician.

11. The method of claim 1 wherein the referral recipient is a pharmacy.

12. The method of claim 1 wherein the referral recipient is a medical supply facility.

13. The method of claim 1 wherein the referral recipient is a medical testing facility.

14. The method of claim 1 wherein the referral recipient is an extended care facility.

15. The method of claim 6 wherein the referral recipient is a specialist physician.

16. The method of claim 6 wherein the referral recipient is a pharmacy.

17. The method of claim 6 wherein the referral recipient is a medical supply facility.

18. The method of claim 6 wherein the referral recipient is a medical testing facility.

19. The method of claim 6 wherein the referral recipient is an extended care facility.

20. The method of claim 1 wherein step (1.j) further comprises transmitting a confirmation notice identifying the referral response to one or more devices designated by the patient.
